(19) United States
(12) Patent Application Publication
(10) Pub. No.: US 2008/0275740 A1
(43) Pub. Date: Nov. 6, 2008

(54) Priority seat management system, priority seat management method, and program storage medium storing program thereof

(75) Inventors: Teruyuki Kono, Osaka (JP); Hiroshi Kitano, Osaka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/907,616

(22) Filed: Oct. 15, 2007

(30) Foreign Application Priority Data
Nov. 24, 2006 (JP) 2006-317362

(51) Int. Cl. G06Q 30/00; G06F 17/30

(52) U.S. Cl. 705/5; 707/104.1; 707/E17.009

(57) ABSTRACT

When a priority passenger detector located at a ticket gate detects priority data transmitted from a priority data storage device 1, a target estimator estimates a plurality of candidate trains which the priority passenger is likely to board. A seat manager reserves priority seats in the individual candidate trains. When a priority passenger detector located at a platform detects a priority passenger, the target estimator narrows down the candidate trains, and the seat manager releases the priority seats reserved in the trains that have become no longer candidates as a result of the narrowing down. When the priority passenger detector located at a train entrance detects the priority passenger, the target estimator determines the train boarded by the priority passenger, and the seat manager releases the priority seats reserved in the candidate trains other than the determined train.

### BACKGROUND OF THE INVENTION

1. Field of the Invention

The present invention relates to systems for managing priority seats in transportation facilities. In particular, the present invention relates to a priority seat management system which provides priority seats in accordance with movements of passengers who are eligible for priority seats.

2. Description of the Related Art

Priority seats are provided in transportation facilities such as trains and buses so that the elderly, pregnant women, sick people, etc. (priority passengers) are given preference regarding seating. The use of priority seats is left to the morals of passengers. In general, passengers other than priority passengers try to use standard seats instead of the priority seats. However, there may be situations where passengers who are eligible for priority seats (priority passengers) cannot use the priority seats since passengers who are not eligible for priority seats (non-priority passengers) have occupied the priority seats. To address this, Japanese Unexamined Patent Application Publication No. 2004-178292 discloses a system allowing a priority seat to be reserved before boarding.

### SUMMARY OF THE INVENTION

However, it is troublesome to make a reservation for a priority seat before boarding. In addition, the number of seats designated as priority seats is fixed at a small number (in an example illustrated in FIG. 8, four seats 8C, 8D, 9C, and 9D serve as priority seats). Thus, in a case where a group of elderly people board a transportation facility, the number of priority seats may be insufficient. In contrast, when there are no priority passengers in the transportation facility, the priority seats may remain vacant.

The present invention has been made in view of the above circumstances. Accordingly, it is an object of the present invention to provide a priority seat management system which allows a reservation of a priority seat on the basis of the movements of passengers who are eligible for priority seats.

One aspect of the present invention provides a priority seat management system which manages a seat in a transportation facility used by a priority passenger who carries a portable storage device storing priority data. The priority seat management system includes: a seat information storage which stores seat information containing seat type data which indicates whether a seat is a standard seat or a priority seat; a first priority passenger detector which reads the priority data stored in the portable storage device; and a seat reserver which changes seat type data stored in the seat information storage which indicates a standard seat so as to indicate a priority seat on the basis of location information of the first priority passenger detector which has read the priority data.

The priority seat management system may further includes a seat type indicator of each seat which displays, in accordance with the seat type data, information which notifies a passenger whether the each seat is a standard seat or a priority seat.

The priority seat management system may further includes: a train diagram storage which stores a train diagram of the transportation facility; and a target estimator which estimates a first candidate car on the basis of the location information of the first priority passenger detector, a first time data of reading the priority data, and the train diagram. The seat reserver changes seat type data of a seat in the first candidate car so as to indicate a priority seat.

The seat information in the priority seat management system may further contain seat state data which indicates whether a seat is vacant or occupied. The seat reserver preferably changes seat type data of a seat which has seat state data indicating vacant so as to indicate a priority seat.

When seat state data of a seat is changed so as to indicate vacant, the seat reserver of the priority seat management system may change seat type data of the seat so as to indicate a priority seat while there is no seat which has seat type data indicating a standard seat and seat state data indicating vacant.

The priority seat management system may further include a second priority passenger detector which reads the priority data stored in the portable storage device. The target estimator further estimates a second candidate car on the basis of location information of the second priority passenger detector which has read the priority data, a second time data of reading the priority data, and the train diagram. The seat reserver changes seat type data of a seat in the second candidate car so as to indicate a priority seat. The seat reserver preferably changes seat type data of the seat in the first candidate car back so as to indicate a standard seat when the first candidate car is different from the second candidate car.

Another aspect of the present invention provides a priority seat management method performed by a priority seat management system which manages a seat in a transportation facility used by a priority passenger who carries a portable storage device storing priority data. The priority seat management system includes a storage which stores seat information containing seat type data which indicates whether a seat is a standard seat or a priority seat. The priority seat management system includes a first priority passenger detector which reads the priority data stored in the portable storage device. The priority seat management method includes the steps of: reading the priority data which is stored in the portable storage device by the first priority passenger detector; and changing seat type data stored in the storage which indicates a standard seat so as to indicate a priority seat on the basis of location information of the first priority passenger detector which has read the priority data.

Yet another aspect of the present invention provides a program storage medium readable by a computer. The program storage medium stores a program of instructions for the computer to execute a priority seat management method for managing a seat in a transportation facility used by a priority passenger who carries a portable storage device storing priority data. The computer includes a storage which stores seat information containing seat type data which indicates whether a seat is a standard seat or a priority seat. The computer can communicate with a first priority passenger detector which reads the priority data stored in the portable storage device. The priority seat management method includes the steps of: receiving the priority data which is stored in the portable storage device from the first priority passenger detector; and changing seat type data stored in the storage which indicates a standard seat so as to indicate a priority seat on the basis of location information of the first priority passenger detector which has read the priority data.

According to the present invention, a priority passenger is detected and an appropriate seat is reserved for the passenger. Thus, a priority seat management system which can prepare priority seats on the basis of the movements of priority passengers can be provided.

### BRIEF DESCRIPTION OF THE DRAWINGS

FIG. 1 is a block diagram illustrating a system configuration of a priority seat management system according to an embodiment of the present invention;

FIG. 2 is a flowchart illustrating a flow of priority seat management process performed by a priority seat management system according to an embodiment of the present invention;

FIG. 3 is a flowchart illustrating a detailed flow of priority seat reservation process according to an embodiment of the present invention;

FIG. 4 is a diagram illustrating a data structure of priority data according to an embodiment of the present invention;

FIG. 5 is a diagram illustrating a data structure of seat information according to an embodiment of the present invention;

FIG. 6 is a diagram illustrating a data structure of log data according to an embodiment of the present invention;

FIG. 7 is a diagram illustrating an example of a seat type indicator according to an embodiment of the present invention;

FIG. 8 is a diagram illustrating a typical existing arrangement of priority seats;

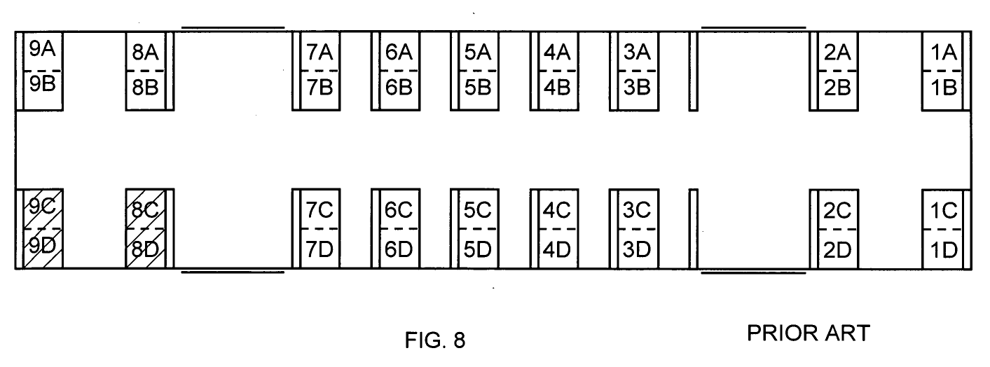

FIG. 9 is a diagram illustrating an example of a reservation of priority seats according to an embodiment of the present invention;

FIG. 10 is a diagram illustrating an example of a reservation of priority seats according to an embodiment of the present invention;

FIG. 11 is a diagram illustrating an example of a dedicated priority seat according to an embodiment of the present invention; and

FIG. 12 is a diagram illustrating an example of a computer environment.

### DESCRIPTION OF THE PREFERRED EMBODIMENTS

In the following, the preferred embodiments of the present invention will be described with reference to the accompanying drawings. The following description will be made using an example of a train as a transportation facility.

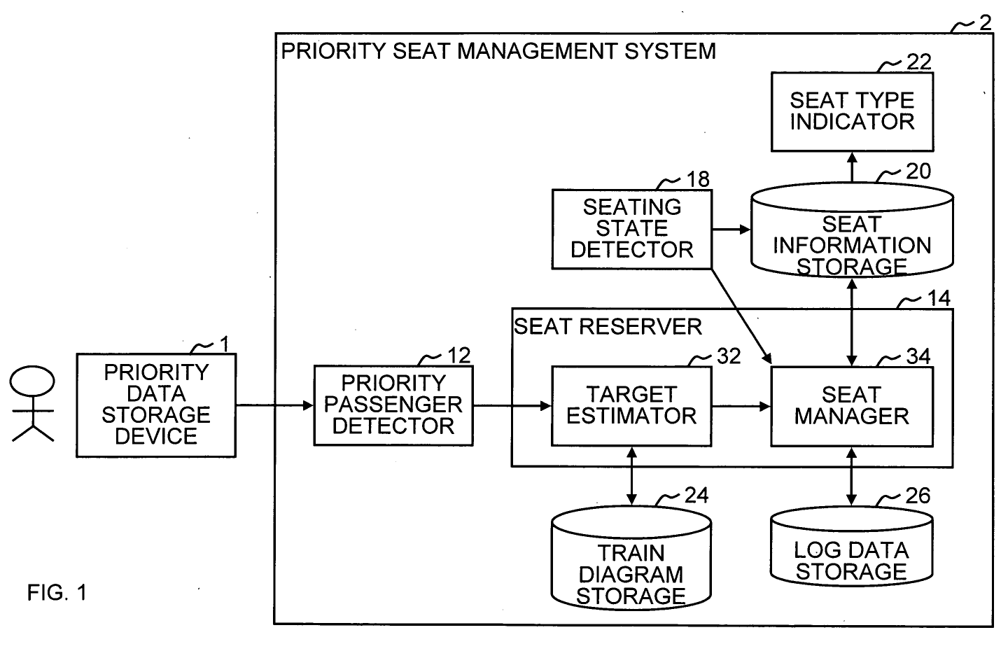

FIG. 1 is a block diagram illustrating a system configuration of a priority seat management system according to an embodiment of the present invention. A priority seat management system 2 according to an embodiment of the present invention has one or more priority passenger detectors 12, a seat reserver 14, a seating state detector 18, a seat information storage 20, a seat type indicator 22, a train diagram storage 24, and a log data storage 26.

Each of the priority passenger detectors 12 detects a signal output from a priority data storage device 1 carried by a passenger who is eligible for a priority seat (hereinafter referred to as detecting a priority passenger). The priority passenger detectors 12 may be located at a plurality of locations. In this embodiment, it is assumed that the priority passenger detectors 12 are located at a ticket gate of a station, a plurality of positions on a platform, and each entrance of a train.

The seat reserver 14 includes a target estimator 32 and a seat manager 34.

When one of the priority passenger detectors 12 located at the ticket gate and the platform detects a priority passenger, the target estimator 32 estimates a train and a train entrance that may be used by the priority passenger. When one of the priority passenger detectors 12 located at entrances of the train detects the priority passenger, the target estimator 32 determines the train and the train entrance used by the priority passenger.

The seat manager 34 reserves a priority seat by designating a standard seat positioned near the estimated entrance of the candidate train as a priority seat. In addition, when the above estimation is invalidated due to refinement of the estimation, the determination of the train entrance, or the like, the seat manager 34 releases the reserved priority seat.

The seating state detector 18 detects whether each seat is vacant or occupied.

The seat information storage 20 stores data indicating a state of each seat in a train. Such data indicating a state of each seat contains data indicating whether the seat is a standard seat or a priority seat and data indicating whether the seat is vacant or occupied. The data indicating a state of each seat also contains data indicating the entrance near each seat.

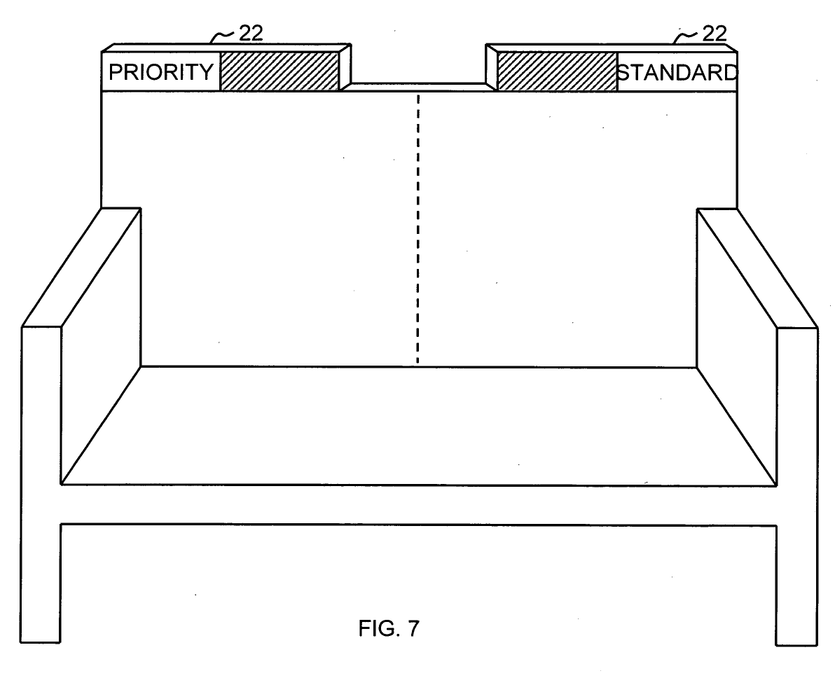

The seat type indicator 22 displays information notifying a passenger whether a seat is a standard seat or a priority seat. Any display scheme can be employed for such display. For example, as illustrated in FIG. 7, it is preferable that the seat type indicator 22 is located on each seat so as to indicate whether the seat is a standard seat or a priority seat.

The train diagram storage 24 stores a train diagram. This train diagram is used when the target estimator 32 estimates a train to be used by a priority passenger.

The log data storage 26 stores a log relating to the state of implementation of the priority seat reservation process.

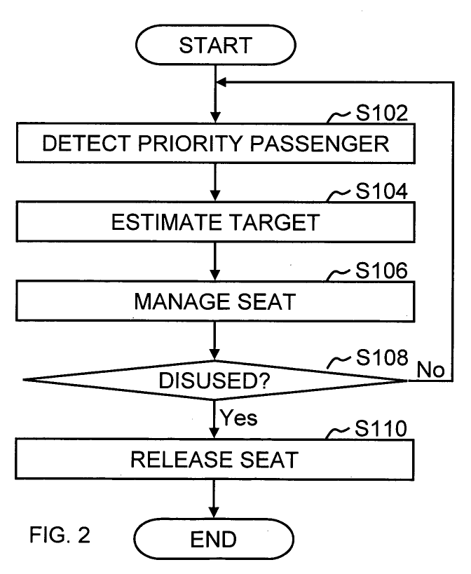

FIG. 2 is a flowchart illustrating a flow of priority seat management process performed by a priority seat management system according to an embodiment of the present invention.

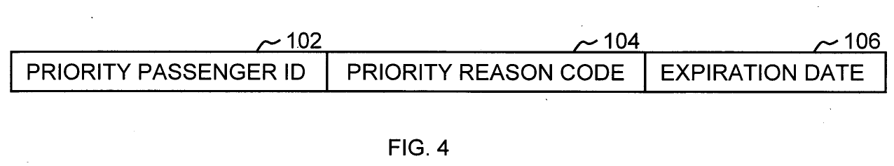

A priority passenger carries a priority data storage device 1 in which priority data indicating that he or she is a priority passenger is stored. The priority data storage device 1 may be any device storing such priority data. It is preferable that the priority data storage device 1 is an IC (integrated circuit) card, a mobile phone, or the like which can be used as a train ticket and is capable of radio transmission of priority data. The content of the priority data may have any data structure as long as the content indicates the user of the priority data storage device 1 is a priority passenger. For example, as illustrated in FIG. 4, the priority data contains a priority passenger ID 102 for identifying the priority passenger, a priority reason code 104 indicating the reason for the priority, and an expiration date 106 indicating a time period during which the priority is effective.

Referring to FIG. 2, a processing flow from STEP S102 to STEP S108 of the priority seat management process will be described.

(STEP S102) When a priority passenger passes through a ticket gate of a station, one of the priority passenger detectors 12 located at the ticket gate detects priority data transmitted from the priority data storage device 1. Thus, the priority seat management system 2 recognizes that the priority passenger has appeared. At this moment, the priority seat management system 2 starts a process of reserving a priority seat for the priority passenger.

(STEP S104) The target estimator 32 estimates a train which the priority passenger is likely to board, on the basis of the train diagram stored in the train diagram storage 24. When there is a plurality of types of trains such as local trains and rapid trains with different stations to stop at, the target estimator 32 sets, for each available train type, the train that leaves the station earliest as a candidate train. That is, there may be a plurality of candidate trains estimated by the target estimator 32. It may also be possible to narrow down the estimated candidate trains on the basis of information on a ticket presented by the priority passenger at the ticket gate. For example, if information on a destination station is obtained from the ticket, a train that stops at the destination, a rapid train that may be used by the priority passenger on the way to the destination, and the like can be set as candidate trains. Alternatively, a train that stops at destination stations which can be estimated by the train fare indicated on the ticket may be set as a candidate train.

(STEP S106) Every car or a specific car of each candidate train is assumed to be a candidate car which the priority passenger is likely to board. A priority seat is reserved for the priority passenger in each candidate car. When there is no vacant seat to be reserved for the priority passenger in a candidate car, the priority seat management system 2 enters a priority seat reservation waiting state in which when a seat in the candidate car becomes available the seat is reserved as a priority seat. Note that seats positioned around every train entrance may be reserved as priority seats or seats positioned only around a specific train entrance may be reserved as priority seats. In the latter case, a car or a train entrance may be estimated on the basis of the position of stairs on a platform of the station or a destination station.

When the priority passenger arrives at a platform, one of the priority passenger detectors 12 located at the platform detects the priority passenger, and the priority seat management process returns to STEP S102. At this time, the estimated candidates obtained in STEP S104 can be narrowed down on the basis of information specifying the platform where the priority passenger has arrived and indicating the position on the platform around which the priority passenger is located. As a result of this narrowing down, some of the candidate trains, candidate cars, or candidate train entrances become no longer candidates, and the seats reserved in these candidate trains or cars, or around the candidate train entrances are released at STEP S106. At this time, if the priority seat management system 2 has been in the priority seat reservation waiting state for another priority passenger, these seats can be kept reserved for the other priority passenger.

When the priority passenger boards a train that has arrived at the station, one of the priority passenger detectors 12 located at a train entrance from which the priority passenger has boarded detects the priority passenger. Thus, the priority seat management process returns to STEP S102. In this case, the train, the car, and the train entrance which the priority passenger actually uses are determined at STEP S104. Thus, the candidates other than the determined train, car, and train entrance can be released at STEP S106. If a priority seat has not been reserved by this time, the priority seat management system 2 has still been in the priority seat reservation waiting state waiting for a seat in an area around the determined train entrance. When any of the seats in this area becomes vacant, the seat is reserved as a priority seat for the priority passenger.

(STEP S108) When the priority passenger passes through a train entrance to exit the train, the priority seat management system 2 determines that the priority seat is no longer necessary.

(STEP S110) When the priority seat becomes unnecessary (STEP S108: YES), the priority seat is released.

According to the above described process, the platform and the train used by each of a plurality of priority passengers detected at a ticket gate of a station during the same time period is not identified. By identifying each priority passenger on the basis of priority data stored in the priority data storage device 1 carried by the each priority passenger, it is also possible to reserve priority seats more effectively for the plurality of priority passengers. The priority passengers can be identified individually by using the priority passenger ID 102 contained in the priority data. However, there may be concern about privacy in identifying individuals. In this case, it is possible to roughly identify each of priority passengers on the basis of the priority reason code 104 or the expiration date 106 contained in the priority data or a combination of the priority reason code 104 and the expiration date 106.

For example, it is assumed that two priority passengers have respectively presented tickets of 130 yen and 230 yen, and one of them has moved to a platform for up-trains and the other has moved to a platform for down-trains. In this case, if these two priority passengers are not distinguished from each other, priority seat reservation process is performed on the basis of estimated destination stations on both the inbound line and the outbound line, and both in a 130-yen zone and a 230-yen zone from the station. However, if the two priority passengers can be distinguished from each other, the priority seat reservation process can be performed differently. For example, it is assumed that the expiration date 106 of the priority data of the priority passenger having the 130-yen ticket is the end of December, and the expiration date 106 of the priority passenger having the 230-yen ticket is the end of March, and that the expiration date 106 of the priority passenger detected at the platform for up-trains is the end of December and the expiration date 106 of the priority passenger detected at the platform for down-trains is the end of March. On the basis of this assumption, stations on the inbound line and in a 130-yen zone from the station are estimated as destination stations, and stations on the outbound line and in a 230-yen zone from the station are estimated as destination stations. Thus, the priority seat reservation process is performed on the basis of these estimated destination stations.

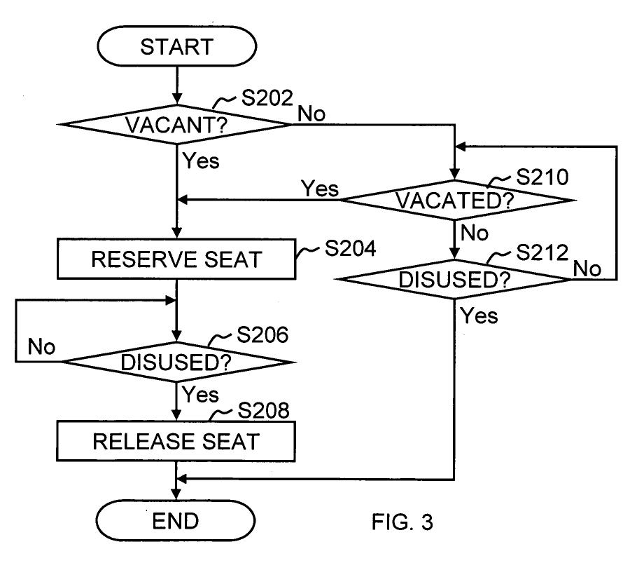

FIG. 3 is a flowchart illustrating a detailed process of priority seat reservation process according to an embodiment of the present invention. Referring to FIG. 3, a processing flow from STEP S202 to STEP S212 of the priority seat reservation process will be described. This priority seat reservation process for reserving a priority seat for one priority passenger is performed for each candidate train, each candidate car, and each area around each candidate train entrance.

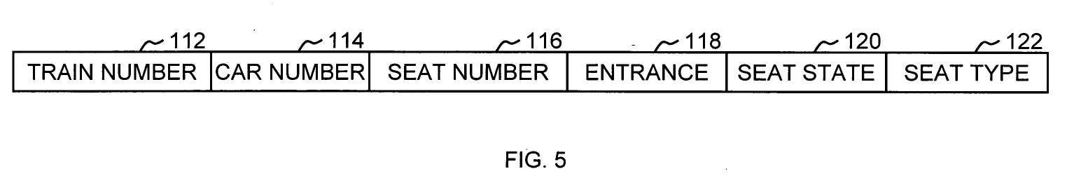

(STEP S202) On the basis of seat information stored in the seat information storage 20, a standard seat which is currently vacant in a target area is searched for. As illustrated in FIG. 5, the seat information stored in the seat information storage 20 contains, for each seat, a train number 112, a car number 114, a seat number 116, an entrance 118 indicating an entrance near the seat, a seat state 120 indicating whether the seat is currently vacant or occupied, and a seat type 122 indicating whether the seat is a standard seat or a priority seat. In this embodiment, so as to reserve a priority seat for a priority passenger, seat information that contains a specific train number 112, a specific car number 114, a specific entrance 118, a seat type 122 indicating a standard seat, and a seat state 120 indicating being vacant is searched for.

(STEP S204) When there are one or more vacant seats (STEP S202: YES), one of the vacant seats is reserved as a priority seat. Then, the seat information in the seat information storage 20 is updated, and the seat type indicator 22 of the seat is switched to indicate a priority seat.

(STEP S206) Thereafter, this priority seat is kept reserved unless the train, car, or train entrance corresponding to the priority seat becomes no longer an estimated candidate regarding the priority passenger, or until the priority seat becomes unnecessary due to his or her exit from the train, for example.

(STEP S208) When the priority seat becomes unnecessary (STEP S206: Yes), the priority seat is released and set as a standard seat. Then, the seat information in the seat information storage 20 is updated, and the seat type indicator 22 of the seat is switched to indicate a standard seat.

(STEP S210) If there are no vacant seats within the target area (STEP S202: No), the priority seat management system 2 enters the priority seat reservation waiting state. When the seating state detector 18 detects occurrence of a vacancy, the process proceeds to STEP S204.

(STEP S212) When the train, car, or train entrance corresponding to the priority seat becomes no longer an estimated candidate regarding the priority passenger, or when the priority seat becomes unnecessary due to his or her exit from the train, for example (STEP S212: Yes), while the priority seat management system 2 remains in the priority seat reservation waiting state (SEP S210: No), the process is terminated.

As described above, according to the present embodiment, when a priority passenger passes through a ticket gate, i.e., when a priority seat is required, the priority seat management system initiates process for reserving a priority seat. Thus, priority seats can be provided in accordance with the movements of priority passengers, and thus priority passengers using transportation facilities are allowed to use priority seats with increased convenience.

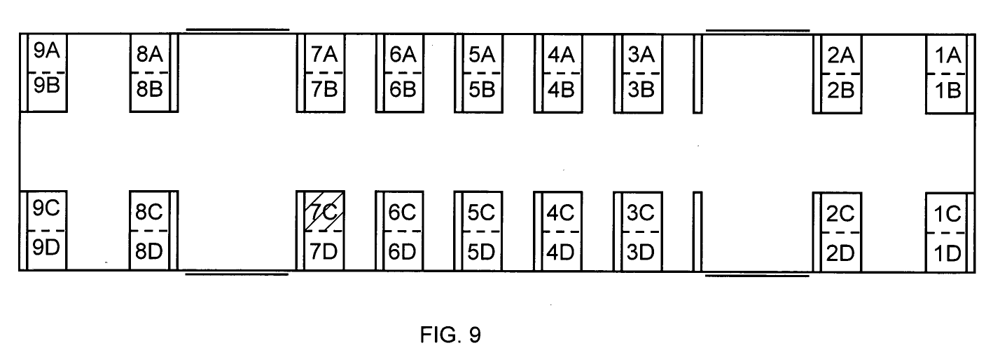

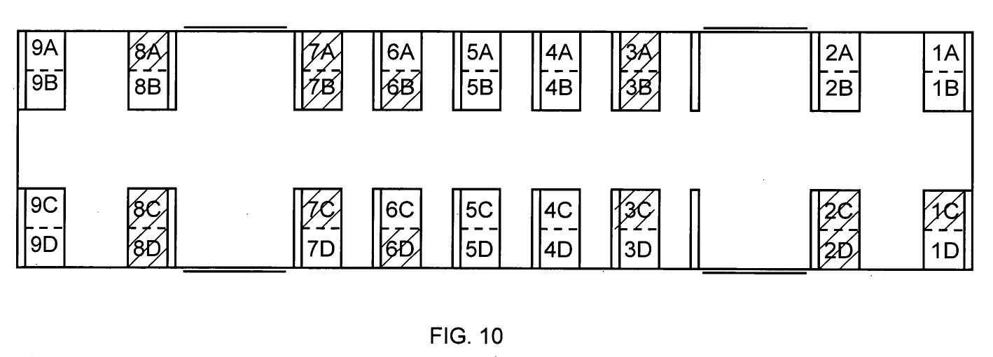

According to an embodiment of the present invention, it is no longer necessary to reserve priority seats all the time regardless of whether or not there is a priority passenger, as has been the case in the past. Thus, depending on the movements of priority passengers, there may be no priority seat in a car of a train or may be only one priority seat as illustrated in FIG. 9. In addition, there may also be a case where many priority seats are reserved as illustrated in FIG. 10.

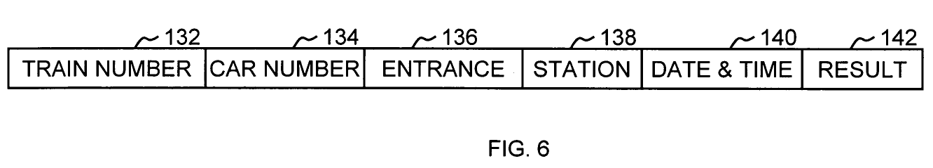

It may also be configured such that a log of results of priority seat reservation process is kept, and on the basis of the log, a priority seat in a specific train, in a specific car, or around a specific train entrance is reserved on a specific day of the week and at a specific time. There may be a case where a reservation attempt for a priority seat for a priority passenger who regularly uses a train frequently fails. However, with the above configuration, it is possible to perform priority seat reservation process beforehand. As illustrated in FIG. 6, log data contains a train number 132 of a train that the priority passenger has boarded, a car number 134, an entrance 136, a station 138, date & time 140 indicating date and time at which the priority seat reservation process was initiated, and a result 142 indicating whether a reservation of a priority seat was successful or failed. For example, when log data strings indicating the same train number 132 and the same station 138 are repeatedly generated and the result 142 of each log data string often indicates “failed”, the date & time 140 is referred to. If the date & time 140 indicates every day use or days and times of use with some regularity, priority seat reservation process is performed every day or on the dates and times based on the regularity at an early time, i.e., before the priority passenger is detected. With this arrangement, it is possible to provide convenience for regular priority passengers.

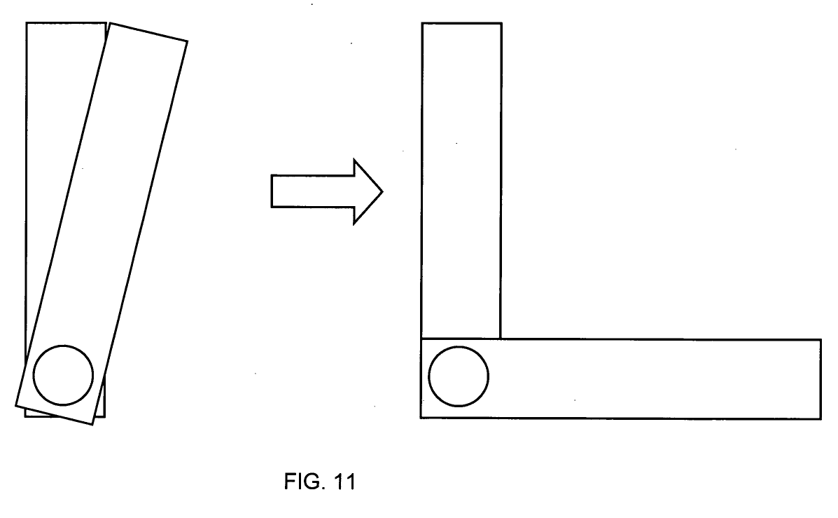

Further, there may often be a case where priority seats are often occupied by non-priority passengers. In such a case, several seats dedicated to priority passengers may be prepared. As illustrated in FIG. 11, such a dedicated priority seat may usually be set unavailable by, for example, being folded up, and may be set available only when a priority passenger is detected at the dedicated priority seat.

While the above embodiments have been described using the examples of seats in a train. However, the present invention is not limited to the examples and is applicable to any transportation facility such as a bus.

The priority seat management system according to the above embodiments may be implemented in either hardware or software in a computer. When the system is implemented as software, for example, the seat reserver 14 can be implemented by creating a program causing a computer to execute the target estimator 32 and the seat manager 34 illustrated in FIG. 1 and loading the program to a memory of a computer.

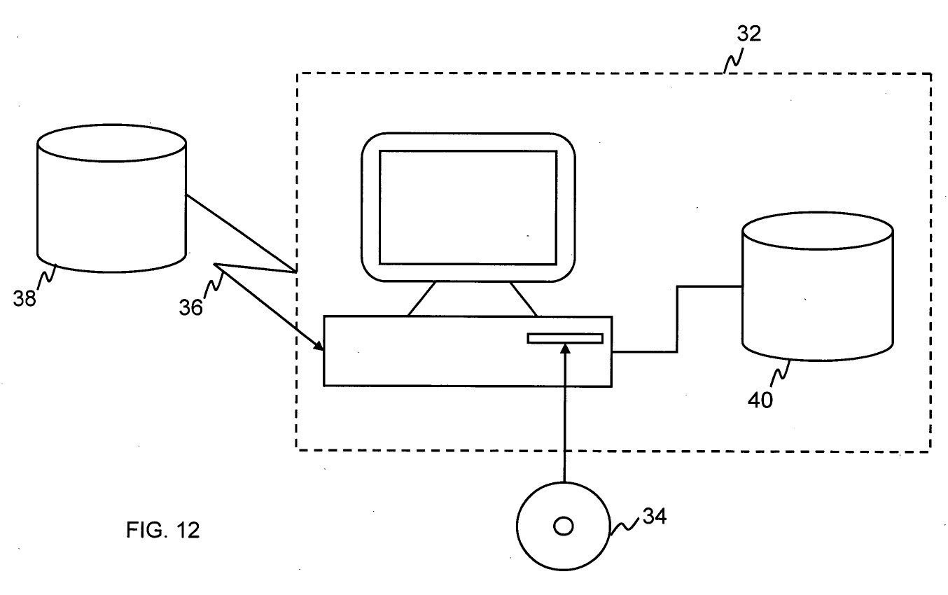

As illustrated in FIG. 12, a program implementing the priority seat management system according to an embodiment of the present invention may be stored not only in a portable storage medium 34 such as a CD-ROM, a CD-RW, a DVD-R, a DVD-RAM, a DVD-RW, and a flexible disc, but also in another storage device 38 provided at an end of a communication line 36 or a storage device/medium 40 such as a hard disk, a RAM or the like of a computer system 32. In execution, the program is loaded and executed on a main memory.

What is claimed is:

1. A priority seat management system for managing a seat in a transportation facility used by a priority passenger carrying a portable storage device storing priority data, said priority seat management system comprising:
a seat information storage for storing seat information containing seat type data alternately indicating a standard seat or a priority seat;
a first priority passenger detector for reading the priority data stored in the portable storage device; and
a seat reserver for changing seat type data stored in the seat information storage indicating a standard seat so as to indicate a priority seat on the basis of location information of the first priority passenger detector having read the priority data.

2. The priority seat management system of claim 1, further comprising:
a seat type indicator of each seat for displaying, in accordance with the seat type data, information notifying a passenger whether the each seat is a standard seat or a priority seat.

3. The priority seat management system of claim 1, further comprising:
a train diagram storage for storing a train diagram of the transportation facility; and
a target estimator for estimating a first candidate car on the basis of the location information of the first priority passenger detector, a first time data of reading the priority data, and the train diagram,
said seat reserver changing seat type data of a seat in the first candidate car so as to indicate a priority seat.

4. The priority seat management system of claim 3,
said seat information further containing seat state data indicating whether a seat is vacant or occupied,
said seat reserver changing seat type data of a seat having seat state data indicating vacant so as to indicate a priority seat.

5. The priority seat management system of claim 4,
said seat reserver changing, upon changing seat state data of a seat so as to indicate vacant, seat type data thereof so as to indicate a priority seat in the absence of a seat having seat type data indicating a standard seat and seat state data indicating vacant.

6. The priority seat management system of claim 3, further comprising:
a second priority passenger detector for reading the priority data stored in the portable storage device,
said target estimator estimating a second candidate car on the basis of location information of the second priority passenger detector having read the priority data, a second time data of reading the priority data, and the train diagram,
said seat reserver changing seat type data of a seat in the second candidate car so as to indicate a priority seat,
said seat reserver changing seat type data of the seat in the first candidate car back so as to indicate a standard seat upon mismatch between the first candidate car and the second candidate car.

7. A priority seat management method performed by a priority seat management system for managing a seat in a transportation facility used by a priority passenger carrying a portable storage device storing priority data, said priority seat management system including a storage for storing seat information containing seat type data alternately indicating a standard seat or a priority seat, said priority seat management system including a first priority passenger detector for reading the priority data stored in the portable storage device, said priority seat management method comprising the steps of
reading the priority data stored in the portable storage device by the first priority passenger detector; and
changing seat type data stored in the storage indicating a standard seat so as to indicate a priority seat on the basis of location information of the first priority passenger detector having read the priority data.

8. The priority seat management method of claim 7, said priority seat management system further including a seat type indicator of each seat for displaying information notifying a passenger whether the each seat is a standard seat or a priority seat, said priority seat management method further comprising the step of:
setting information, in accordance with the change of the seat type data, to a corresponding seat type indicator.

9. The priority seat management method of claim 7, said priority seat management system further including a storage for storing a train diagram of the transportation facility, said priority seat management method further comprising the step of
estimating a first candidate car on the basis of the location information of the first priority passenger detector, a first time data of reading the priority data, and the train diagram,
in said step of changing seat type data, seat type data of a seat in the first candidate car being changed so as to indicate a priority seat.

10. The priority seat management method of claim 9,
said seat information further containing seat state data indicating whether a seat is vacant or occupied,
in said step of changing seat type data, seat type data of a seat having seat state data indicating vacant being changed so as to indicate a priority seat.

11. The priority seat management method of claim 10,
in said step of changing seat type data, upon changing seat state data of a seat so as to indicate vacant, seat type data thereof being changed so as to indicate a priority seat in the absence of a seat having seat type data indicating a standard seat and seat state data indicating vacant.

12. The priority seat management method of claim 9, said priority seat management system including a second priority passenger detector for reading the priority data stored in the portable storage device, said priority seat management method further comprising the steps of
reading the priority data stored in the portable storage device by the second priority passenger detector,
estimating a second candidate car on the basis of location information of the second priority passenger detector having read the priority data, a second time data of reading the priority data, and the train diagram,
in said step of changing seat type data, seat type data of a seat in the second candidate car being changed so as to indicate a priority seat,
in said step of changing seat type data, seat type data of the seat in the first candidate car being changed back so as to indicate a standard seat upon mismatch between the first candidate car and the second candidate car.

13. A program storage medium readable by a computer, said program storage medium storing a program of instructions for the computer to execute a priority seat management method for managing a seat in a transportation facility used by a priority passenger carrying a portable storage device storing priority data, said computer including a storage for storing seat information containing seat type data alternately indicating a standard seat or a priority seat, said computer being capable of communicating with a first priority passenger detector for reading the priority data stored in the portable storage device, said priority seat management method comprising the steps of
receiving the priority data stored in the portable storage device from the first priority passenger detector; and
changing seat type data stored in the storage indicating a standard seat so as to indicate a priority seat on the basis of location information of the first priority passenger detector having read the priority data.

14. The program storage medium of claim 13, said computer being capable of communicating with a seat type indicator of each seat for displaying information notifying a passenger whether the each seat is a standard seat or a priority seat, said priority seat management method further comprising the step of:
setting information, in accordance with the change of the seat type data, to a corresponding seat type indicator.

15. The program storage medium of claim 13, said computer further including a storage for storing a train diagram of the transportation facility, said priority seat management method further comprising the step of
estimating a first candidate car on the basis of the location information of the first priority passenger detector, a first time data of reading the priority data, and the train diagram,
in said step of changing seat type data, seat type data of a seat in the first candidate car being changed so as to indicate a priority seat.

16. The program storage medium of claim 15,
said seat information further containing seat state data indicating whether a seat is vacant or occupied,
in said step of changing seat type data, seat type data of a seat having seat state data indicating vacant being changed so as to indicate a priority seat.

17. The program storage medium of claim 16,
in said step of changing seat type data, upon changing seat state data of a seat so as to indicate vacant, seat type data thereof being changed so as to indicate a priority seat in the absence of a seat having seat type data indicating a standard seat and seat state data indicating vacant.

18. The program storage medium of claim 15, said computer being further capable of communicating with a second priority passenger detector for reading the priority data stored in the portable storage device, said priority seat management method further comprising the steps of
receiving the priority data stored in the portable storage device from the second priority passenger detector,
estimating a second candidate car on the basis of location information of the second priority passenger detector having read the priority data, a second time data of reading the priority data, and the train diagram,
in said step of changing seat type data, seat type data of a seat in the second candidate car being changed so as to indicate a priority seat,
in said step of changing seat type data, seat type data of the seat in the first candidate car being changed back so as to indicate a standard seat upon mismatch between the first candidate car and the second candidate car.
